(19) United States
(12) Patent Application Publication
(10) Pub. No.: US 2023/0010026 A1
(43) Pub. Date: Jan. 12, 2023

(54) SYSTEM AND METHOD FOR REMEDIATION OF WASTE PRODUCTS

(71) Applicant: Chiang Chik Tai, Kepong (MY)

(72) Inventor: Chiang Chik Tai, Kepong (MY)

(21) Appl. No.: 17/849,830

(22) Filed: Jun. 27, 2022

(30) Foreign Application Priority Data
Jul. 8, 2021 (MY) PI2021003892

(51) Int. Cl. B09B 3/70; C05F 7/00; B01J 20/28; B01J 20/26; B01J 20/24; B01J 35/02; B01J 35/00; B01J 31/06; C10G 1/00; B01D 65/02; B09B 3/10

(52) U.S. Cl. CPC B09B 3/70; C05F 7/00; B01J 20/28016; B01J 20/28007; B01J 20/26; B01J 20/24; B01J 35/026; B01J 35/0013; B01J 31/06; C10G 1/00; B01D 65/02; B09B 3/10; C10G 2300/1003; B01D 2321/168; B09C 1/08

(57) ABSTRACT

The invention provides novel remediants and methods for remediating all biological and synthetic fibers; and biological and synthetic membranes. The remediants comprise a chemically or biologically active or inactive material, in the form of particles which are on average less than the pore size of the selected fiber, or larger than the pore size of the selected membrane, and a polymeric elution supporter suspension which is interactive with an environmentally acceptable solvent. The elution support suspension mixture is capable of maintaining the particles in a persistent suspension which can permeate through the interwoven fiber layers and pores; or brush membrane surfaces and pores, due to it small or large size, thereby delivering the remediant to the desired fiber and membrane locations.

### TECHNICAL FIELD

This invention generally relates to the use of particle suspension technology for remediation of agricultural and industrial by-products and fibrous materials, including but not limited to converting waste into viable biofuels and other marketable products.

### BACKGROUND

Environmental pollution is one of the primary issues that society faces today, incentivizing the exploration of new technologies for the remediation of contaminants of the air, water, and soil. Environmentally friendly “waste to wealth” sustainability programs are becoming increasingly important to exploit and utilize biomass fibers like natural fibers, agricultural waste fibers and industrial timber waste, to produce new high-value products. It is important that remediation processes not only be sustainable, recyclable, and biodegradable, but also cost-effective and efficient. One example where improved remediation process is essential involves the conversion of Oil Palm Empty Fruit Bunch (OPEFB) fibers to biofuels.

Due to the performance, biodegradable nature, drastic drop of palm oil commodity price, and abundance of palm oil raw materials especially in Southeast Asia, the palm oil industry has been looking for additional markets for palm oil by products including OPEFB fibers. Traditionally, OPEFB is used for steam power generation in palm oil mills, and also used for composting and soil mulch.

The sustainability issues of petroleum-based fuel supply such as depletion of petroleum resources and uncertain crude oil market prices, as well as environmental problems such as increasing emissions of harmful pollutants and greenhouse gases, now drives global focus on the utility of OPEFB as a viable competitive biofuel, serving as a renewable energy source and primary alternative to petroleum-based fuel.

However, the palm oil industry faces several challenges today in existing biomass energy conversion systems primarily due to operating problems such as ash deposition (fouling and slagging) and agglomeration, which has a significant effect on biofuel quality. These operating problems are mainly caused by inherent composition and properties of OPEFB fibers which naturally presents as macronutrients for biomass growth, specifically alkali elements like potassium.

One challenge to the viability and competitiveness of the above processes is the amount of potassium, chlorine, and sodium content in view of salt limitations required by the biofuel industry standards, and challenges to further improve Calorific Value (CV) of biofuel for energy utilization.

The potassium challenge has resulted in most producers garnering a much lower or no price for their OPEFB fiber biofuel, for minimal use in their own country only, rather than the higher price for low potassium OPEFB fiber biofuel for export. In the last five to seven years, large sums have been spent by large palm oil conglomerates on lowering potassium content in their products without success.

Conventional methods for conversion include a thermo-chemical method where the OPEFB fibers are pelletized for use in incinerators and power generation for utility stations in response to market demands today, mainly in Japan and other palm oil abundant countries. Other conventional methods include hydrothermal treatment and water leaching. However, the foregoing methods are less than ideal. Water and traditional chemistries are not able to remove the tightly bound and stable potassium in the OPEFB fibers. For example, to date producers have not been able to reduce the nutrients content, especially potassium, to less than one thousand five hundred (1500) parts per million (ppm) that the biofuel industry requires. Occasionally the producers may reduce the potassium down to one thousand one hundred (1100) ppm but they are not able to consistently maintain this low level.

For several decades global energy demand and consumption have increased, and indiscriminate use of finite fossil fuel resources has led to environmental problems including global warming and climate change. With continuous and increasing need for energy, it can be appreciated that improved systems and methods for effective, renewable and environmentally friendly energy sources like OPEFB fiber biofuel are of great use to the palm oil industry and the general public.

The present inventors have recognized a number of shortcomings of existing systems and methods for converting OPEFB and other fibers to viable and competitive biofuel, to which the following disclosure is directed.

### SUMMARY

Aspects of the invention relate to systems and methods to remediate and remove nutrients from and/or to detoxify contaminated biological fibers, synthetic fibers, biological membranes, synthetic membranes. In some aspects, this allows the remediation process to recycle and reuse process water with novel use of filtration, and to recover undesirable contaminants as viable fertilizers.

The present disclosure describes novel systems and methods for remediation using micro to nanoparticle materials (collectively referred to herein as “remediants”) to mitigate contamination of OPEFB fibers and other biological and synthetic fibers for use or reuse as valuable environmentally sustainable products. In various aspects, the present systems and methods provide chemical or biological remediants; active or inactive remediants; customizable particle size to ensure successful delivery to various materials; increased ease of application and delivery; compatibility with various materials; and ensured sustainability of remediants and remediation process.

Accordingly, one embodiment is directed to a system of environmental particle remediants to decontaminate fibers and membranes, comprising at least one chemically or biologically active or inactive particulate material, further comprising a particle for augmenting the elimination of an environmental contaminant from the selected fiber and membrane remediation site and polymeric support molecules, and having a mean diameter of less than the pore size of selected fibers and larger than pore size of selected membranes; and a polymeric elution supporter, such elution supporter being soluble or capable of forming a suspension in an environmentally acceptable solvent or maintaining them in suspension for a greater time than such particles would be suspended in the absence of the elution supporter, where the amount of remediant is effective to remove or detoxify the nutrient or contaminant. Those skilled in the art will know that polymeric support molecules and pore sizes can be characterized by effective or approximate equivalent diameter sizes, which can be measured for example using an optical or electron microscope or other suitable method.

Another embodiment is directed to a method for remediation by selection, application and delivery/contact of environmental particle remediants in relation to target fibers and membranes thereby reducing the presence of nutrient contaminants, comprising steps to select an environmental remediant which is chemically or biologically active with the contaminant; contacting the selected fibers or membranes by applying the composite remediant to the surface and allowing it to brush, penetrate or diffuse through the fibers, membranes; and achieve sustainability by using membrane treatment to limit discharge and reuse wastewater.

Particle remediants may in some embodiments comprise salt-based or metal-based.

Remediant application may be in some embodiments sprayed on, poured on, injected into, pumped in a loop, or applied in any manner of applying a liquid to a solid surface. Following application to the overlaying fiber or membrane surface, the remediant may be further delivered into the interwoven fiber layers through diffusion or further application of solvent to help the remedy permeate for example, fiber pores. Remediants may be injected or pumped in the by means of pneumatic or hydraulic pressure.

Aspects of the remediation treatment process includes use of closed loop filtration membrane cleaning or regeneration to achieve low to zero wastewater discharge; and may be done in a single batch, applied periodically or continuous conveyance, depending on the requirements.

Aspects of the remediation treatment process may comprise the use of active or inactive particle remediants to simultaneously clean membranes chemically or physically.

### BRIEF DESCRIPTION OF THE DRAWINGS

For a fuller understanding of the nature and advantages of the present technology, reference is made to the following detailed description of preferred embodiments and in connection with the accompanying drawings, in which:

FIG. 1 illustrates exemplary remediant wash chemistries;

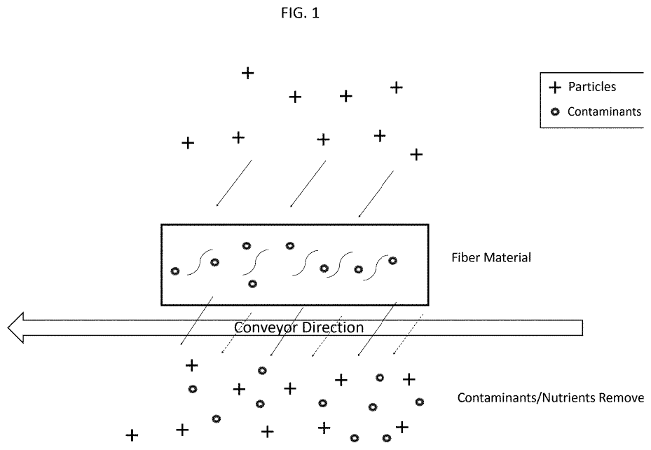

FIG. 2 illustrates a block schematic diagram of a Fiber Washing and Membrane Recycling Process;

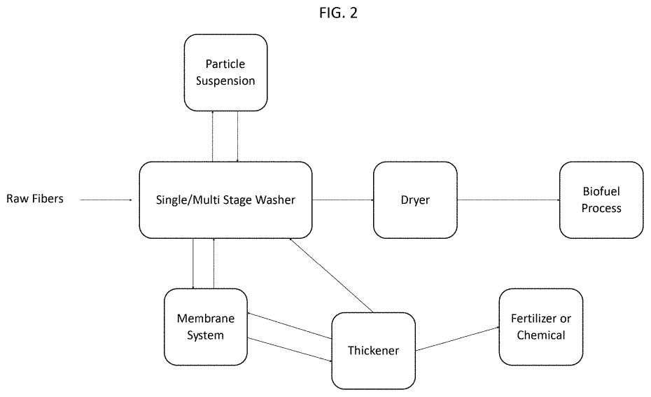

FIG. 3 illustrates a table showing water usage for conventional chemistries versus the particle chemistries of this invention.

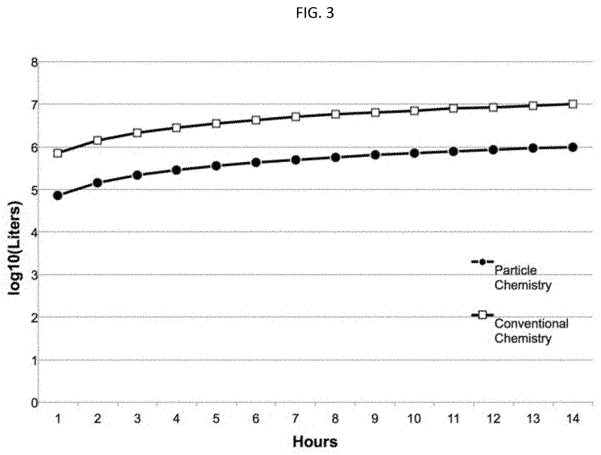

### DETAILED DESCRIPTION

Embodiments of the present invention remediate potassium contaminant levels in OPEFB fibers to lower than one thousand (1000) ppm with particles custom designed to penetrate the OPEFB fiber pores. This level of potassium has not been achieved by OPEFB fiber biofuel producers in the prior art and meets previously unmet industry standards.

Another aspect of the invention utilizes environmentally friendly and sustainable custom designed particle technology that will make OPEFB fibers a viable sustainable biofuel. The particles can range from small nano to large micro particles depending on the pore sizes of the particular fiber to be remediated. This success has now led to applying this novel invention on other fibers such as bamboo fibers and polyamide fibers.

Yet another aspect of the invention remediates and decontaminates all but not limited to, plant and biological fibers such as palm oil trunks, coconut fibers and other agricultural by products into sustainable, carbon net neutral biofuels and reduce the need for open burning during agricultural replanting processes. The invention may in further aspects also remediate and decontaminate synthetic fibers.

Industrialized nations that uses biofuel now requires biofuel production to be environmentally sustainable, such as minimal or zero wastewater discharge and solid waste generation; which the OPEFB producers have not been able to achieve to date.

This novel invention will enable the OPEFB production process to be of minimal to zero wastewater discharge and solid waste generation; with the ability to recycle and reuse most production wastewater and minimal waste generation, since the solid waste will be converted to viable fertilizers. The environmentally sustainable production process is achieved with the novel use of particle chemistry for fiber remediation, and novel membrane regeneration and filtration; for complete reuse of process water and recovery of undesirable nutrients into fertilizers.

Provided in the present invention are novel environmental remediants and methods for their delivery. The environmental remediants comprise chemically or biologically active or in active material in the form of particles with average diameter of less than the pore size of biological, synthetic fibers, larger than biological, synthetic membranes, together with an elution supporter for enhanced permeability of interwoven and overlaying layers. The remediants are delivered to contaminated fibers and membranes. In preferred embodiments, the particles are colloidal particles and the elution supporter is a carbonaceous or polymeric molecule which does not bind substantially to the fibers, membranes, or soil, sand, silt, clay, soil organic matter, or minerals that are undesirable or contaminants to the fibers or membranes. Alternatively, the elution supporter may be designed to bind preferentially to one fiber or contaminant component, such as the soil organic matter and minerals, where the remediant particles are most needed.

In one aspect, the invention is directed to environmental remediants comprising at least one chemically or biologically active or inactive particulate material. The particles have a mean diameter of less than the pore size of selected fibers, larger than pore size of selected membranes, as measured by optical or electron microscopy. These preferred remediants further comprise a polymeric elution supporter, such elution supporter being soluble or miscible or capable of forming a suspension in an environmentally acceptable solvent. The polymeric elution supporter is capable of suspending the particles in the solvent or maintaining them in suspension for a greater time than such particles would be suspended in the absence of the elution supporter.

The invention also provides environmental remediants comprising a particle for augmenting the elimination of an environmental contaminant from the selected fiber and membrane remediation site, wherein the particle has an effective diameter of less than the pore size of selected fiber, larger than pore size of selected membranes, as determined by optical or electron microscopy. In a preferred embodiment, the particle has reactive or catalytic properties for detoxifying and removing the environmental nutrient or contaminant.

The invention is also directed to methods of reducing the presence of a nutrient or contaminant in selected fibers or selected membranes, comprising the steps of: selecting an environmental remediant which is chemically or biologically active with the contaminant; and contacting the selected fibers or selected membrane, with a composition comprising the remediant in the form of particles of mean diameter less than the pore size of selected fiber, larger than pore size of selected membranes, as measured by optical or electron microscopy, together with an elution supporter which is soluble or miscible or which forms a suspension in an environmentally acceptable solvent, where the amount of remediant is effective to remove or detoxify the nutrient or contaminant.

The present invention is directed to environmental remediants comprising at least one chemically or biologically active material, in the form of particles having average diameter, as measured by optical or electron microscopy, less than selected fiber pore size; larger than pore size of selected membranes, and a polymeric elution supporter which is substantially soluble or miscible, or which forms a suspension in an environmentally acceptable solvent, wherein the polymeric elution supporter is capable of maintaining the particles in suspension in the solvent for a period of time longer than they would remain suspended without the polymeric elution supporter.

In preferred embodiments, the chemically or biologically active material comprises a reactive or catalytic material. The selection of the specific remediant will be highly situation specific. For example, the specific remediant chosen will often depend on the characteristics and spatial distribution of the contaminant within the fibers or membranes to be remediated. Examples of chemically active compounds useful for remediation are known to those of skill in the art. Such chemicals are able to detoxify, as defined herein, environmental nutrients or contaminants. In some cases, the chemical compound may be catalytic and accelerate a reaction that would otherwise occur but more slowly.

The invention provides remediants having the ability to reduce the harmful environmental effects of the contaminant of interest. The harmful effects can be reduced by, for example, binding to the contaminant, converting the contaminant to something less toxic, or otherwise detoxifying and removing the contaminants.

A presently preferred embodiment features particles comprising metallic articles. In such embodiments of the invention, the particles contain one or more metals selected from Ag, Al, Au, Ca, Cu, Fe, K, Mg, Mn, Na, Ni, Pd, Pt and Zn; and non metallic particles including but not limited to semi precious crystals such as quartz, garnets, and non precious sand and clays. Particles that contain metal are more preferable. Particles may comprise metals as well as other material. Mixtures of particles are within the scope of the present invention as well. More preferred are metallic oxides, bimetallic particles or mixtures of metallic particles containing at least two metals, where a first metal has a reductant property and a second metal has a catalytic property. The first metal and the second metal are preferably in electrical contact with each other. Where particles containing Al or Cu as a first metal are used, preferred second metals include Pd, Pt and Ni. In presently preferred embodiments bimetallic nanoparticles with ratios of from about 1:1 to about 1:500 catalytic metal to reductant metal are effective as remediants.

The various aspects of the invention are not intended to be limited by the foregoing description of chemically or biologically active remediant compounds—they merely serve to exemplify chemically or biologically active compounds useful with the present invention.

A feature of the present invention is the particles comprising the chemically or biologically active material. The particles, in one aspect, are preferably small. While the particles are typically less than one micron with respect to average diameter, the majority of particles preferably are less than 500 nanometers with respect to average diameter. Even more preferable are particles which are less than 300 nanometers in effective diameter. Particles with a range of diameters are useful. Particles with a range of diameters of less than about 1 micron to less than about 1000 micron are preferred. In more preferred embodiments, particles range in diameter from less than about 30 microns to about 300 microns, from less than about 50 microns to about 200 microns, less than about 3 microns to about 30 microns, or from less than about 1 micron to about less than 100 microns. Particle size may be determined by a variety of methods known in the art. Preferred methods of determining average particle diameter are microscopic methods, including optical and electron microscopy.

In another aspect, the surface-to-volume ratio of the particles and the elution supporter is preferably high relative to larger particles. High surface-to-volume ratios are particularly useful where the detoxification process requires, involves or is facilitated by surface interactions, such as adsorption, with the particles or the elution supporter.

In one aspect of the invention, the lifetime of the remediant particles in the environment is sufficiently long to allow decontamination and detoxification of at least a portion of the contaminant. Therefore, allowing the environmental remediants to be used multiple times on a continuous conveying wash process of biological and synthetic fibers to meet biofuel standards. it may be desirable to suppress certain parasitic processes, such as background corrosion of the remediant in the environment. In preferred embodiments the lifetime of the remediant in the environment is sufficiently long to allow substantial decontamination and detoxification of the contaminant, or even complete detoxification of the contaminant. Most preferably, the lifetime of the remediant particles is considered in determining the total ‘dose’ of remediant required to deliver an amount effective to completely remediate the contaminant in one or more applications of the remediant, in a manner analogous to determining a course of therapy for a patient where a drug delivery system is used.

The polymeric elution supporter s of the present invention are soluble, or miscible, or capable of forming a suspension, preferably a colloidal suspension, with an environmentally acceptable solvent as defined herein. The ability of the polymeric elution supporter to interact with the solvent by either dissolving, mixing or forming a suspension. The polymeric elution supporter interacts with the remediant particles on a chemical or physical basis, such that the polymeric elution supporter is capable of maintaining the particles in suspension in the solvent for longer than the particles would have remained in suspension in the solvent in the absence of the polymeric elution supporter. In preferred embodiments, the particles remain in suspension 10, 50, or 100 times longer in the presence of the elution supporter than in its absence. Preferred elution supporters are capable of maintaining the remediant in a persistent suspension, as defined herein. In more preferred embodiments the suspension formed is colloidal and is stable indefinitely. The advantage provided by this novel aspect of the present invention is particularly relevant where the remediant comprises zero valent metal particles. The particles are known to agglomerate and aggregate, which can reduce their utility for remediation.

Laboratory assessment of polymeric elution supporters is facilitated, for example, on 30 cm columns of selected fibers, by measuring the quantity or activity of a remediant eluting through a fiber of interest. Preferred elution supporters are those which allow remediants to elute more extensively than remediants lacking the eluting supporters. Other factors, such as speed of elution, may be considered in selecting an elution supporter. Additionally, elution supporters s which transit some fibers but bind to specific types of fiber have utility for remediating contaminants bound to that fiber.

The polymeric elution supporters are preferably porous material, and also have a large surface-to-volume ratio. In a presently preferred embodiment, the polymeric elution supporter is a carbonaceous material.

In other preferred embodiments water-soluble polymers are selected for use as elution supporters In particular, the polymeric elution supporters are preferably selected from synthetic polymers, microbial products, marine gums, seed gums, plant exudates and other natural hydrocolloids.

In a presently preferred embodiment, the polymeric elution support is negatively charged at the pH of use. In particular, the surface charge of the polymeric molecule should be considered. The pH of use is preferably between about pH 5 and about pH 11. More preferably, the pH of use is between about pH 6 and about pH 9. The elution supporter need not have a net negative charge over this entire range, but rather it is preferred that the have a net negative charge at the pH which corresponds to the fiber or membrane pH at the remediation surface. The pH at this locus of remediation may be a narrower range, for example 6.8-7.5. A polymeric elution support which has a net negative charge at this pH is preferred.

Still more preferable are polymeric elution supporters which do not, under conditions of actual use, bind substantially to the fiber, membrane contaminated with soil, soil organic matter, sand, clay, or silt particles present at the locus of remediation, independent of the pH or net charge of the molecule. A preferred elution supporter will allow the remediant to permeate the fiber substantially better than the same remediant in the absence of the elution supporter. One useful measure of this is the ability to elute the remediant from test fiber column containing selected fiber. Preferred elution supporters will facilitate 10-, 100-, or 1000-fold or more elution as compared with the same remediant in the absence of the elution supporter.

A highly preferred elution supporter has the ability to deliver the remediant particles to a contaminated fiber, or membrane without substantial losses due to binding to overlaying matter and without being excluded due to size restrictions of the fiber, membrane. The more highly preferred elution supporter, therefore, is that elution supporter which stably suspends the remediant particles, which does not substantially bind to the overlaying or intervening fiber, membrane or layers and which permeates the fiber pores to deliver the remediant to the contaminated fiber or membrane.

In another aspect, the environmental remediants can adsorb environmental contaminants. In a preferred embodiment, fiber, membrane contaminants which are bound to fiber, membrane or soil and other particles at the remediation site preferentially adsorb to the environmental remediant and this adsorption process facilitates the decontamination or detoxification of the contaminant. In preferred embodiments, the surfaces of the elution supporter or remediant particles provide adsorption sites for the contaminant. In more preferred embodiments, the adsorption sites are abundant, and the contaminant tends to partition with the environmental remediant. In a highly preferred embodiment, the adsorption sites are abundant, and the adsorption process brings the contaminant in close proximity to the reactive or catalytic component of the remediant particles, thereby facilitating the decontamination or detoxification process.

In another of its aspects, the invention provides environmental remediants comprising a particle for augmenting the elimination of an undesirable nutrient or contaminant from fibers, membrane, and a polymeric support molecule, wherein the particle has an effective diameter of 1 micron or less. This aspect of the invention is particularly useful wherein the remediants are catalysts or otherwise possess a chemically or biologically active material which augments the detoxification of undesirable nutrients or contamination. It is known that certain contaminants are from the environment at extremely slow rates. The remediants may be catalysts which increase the rate of such reactions, or cofactors for a reaction, such as an enzymatic reaction, or growth factors for a biological organism which is present. In other embodiments the remediants will have reactivity with the contaminant or be capable of detoxifying the contaminant independent of the slow reaction already in place.

In preferred embodiments, the associations between a polymeric support molecule and a remediant particle can range from one of weak physical forces or chemical interactions to covalent bonds between the particle and the polymeric support material. Although the invention is in no way limited to a particular mechanism or type of association between the polymeric support molecules and the particles, in one embodiment, the polymeric support molecule comprises a macroscopic hydrophobic surface or ligating groups for retaining the particle. The ligating groups can comprise groups capable of binding in some fashion with the particles. Where the particles are particulate metals, useful ligating groups for the polymeric support material include but are not limited to aldehydes, alcohols, amines, carboxamates, carboxylates, ethers, hydroxamates, ketones, nitrites, phosphonates, phosphates, pyridines and sulfonates and other groups known to bind or interact with metals.

In preferred embodiments, the contacting is performed by applying the remediant to the surface and allowing it to brush, penetrate or diffuse through the fibers, membrane, with further application of solvent or water, across membrane surfaces or through the fibrous layers. The contacting may also be carried out by any methods known to those of skill in the art for application of remediants to contaminated fibers, membrane. For example, remediants can be sprayed, or pumped in a closed loop system, through means known in the art, such as through the application of hydraulic or pneumatic pressure.

The remediant is applied to the surface of the remediation site, on a surface which overlays the subsurface fiber, membrane to be treated. The remediant can be sprayed on, poured on, pumped in a loop, or applied in any manner of applying a liquid to a solid surface. The remediation treatment may be in a single batch, applied periodically or continuous conveyance, depending on the requirements. Following application to the overlaying surface, the remediant may be further delivered into the interwoven fiber subsurface layers through diffusion, or through a further application of solvent to help the remediant permeate the fiber pores. The remediant is thereby placed in contact with the contaminant. Alternatively, a suspension of the remediant may be pumped in a loop, the interwoven fiber subsurface by means of pneumatic or hydraulic pressure. In this case the increased mobility of the remediant in the fiber subsurface provides an advantage over the use of suspensions of unsupported particles.

The present invention is not limited to the embodiments described herein and exemplified above, but is capable of variation and modification without departure from the scope of the appended claims, such as, but not limited to the application of active remediant particles smaller than the pore size of bamboo or other biological fibers; or the application of inactive remediant particles to decontaminate polyamide or other synthetic fibers.

What is claimed is:

1. An organized suspension of environmental remediants, for remediation of agricultural and industrial by-products and fibrous materials, comprising at least one chemically or biologically, active or inactive, in the form of particles of varying sizes wherein:
an active remediant has an average diameter less than the pore size of the selected fiber, as measured by optical or electron microscopy;
an inactive remediant has an average diameter more than the pore size of the selected fiber, as measured by optical or electron microscopy; and
a remediant has an average diameter more than the pore size of the selected membrane; and
a polymeric elution supporter that is soluble, miscible or suspendable in an environmentally acceptable solvent, said polymeric carrier maintain said particles in suspension in the solvent.

2. The organized suspension of claim 1, said environmental remediant having a net surface charge at a pH required to remove contaminants or nutrients.

3. The organized suspension of claim 2 wherein the pH of use is at the desired location of remediation for selected fiber and membrane.

4. The organized suspension of claim 1 wherein the polymeric elution support is chemically compatible with the remediant at the desired reaction rate.

5. The organized suspension of claim 1 wherein the polymeric carrier comprises a ports material.

6. The organized suspension of claim 1 wherein the polymeric elution support is soluble in water or other solvents.

7. The organized suspension of claim 1 wherein the polymer is synthetic polymer, microbial product, marine gum, seed gum, plant exudate, natural hydrocolloid, modified cellulose or a mixture thereof.

8. The organized suspension of claim 1 wherein the chemically or biologically active material can detoxify undesirable nutrient or contaminant.

9. The organized suspension of claim 1 wherein the chemically or biologically active or inactive material comprises quartz, garnet, non precious clays, colloids, and sand, metal, zero-valent metal, metal oxide, an organic compound, inorganic compound, an oxidant, a reductant, a catalyst, an enzyme, a biologically active molecule, a biological organism or a mixture thereof.

10. The organized suspension of claim 1 wherein the particles comprise nano particles and micro particles.

11. The organized suspension of claim 1 wherein the particles range from <200 nanometers to <300 micron.

12. The organized suspension of claim 10 wherein the particle has reactive or catalytic properties for detoxifying or removing the environmental nutrient or contaminant.

13. The organized suspension of claim 10 wherein the environmental nutrient or contaminant can absorb the remediant.

14. The organized suspension of claim 10 wherein the polymeric support molecule is soluble in a solvent, and the solvent is environmentally acceptable.

15. The organized suspension of claim 14 wherein the solvent is aqueous or non-aqueous.

16. The organized suspension of claim 10 wherein the biological fibers, synthetic fibers, biological membrane and synthetic membrane contains one or more environmental nutrients or contaminants.

17. The organized suspension of claim 10 wherein the carrier prolongs the effective lifetime of the particles.

18. The organized suspension of claim 10 wherein the carrier comprises at least one of carbonaceous materials, synthetic polymers, natural polymers, metal oxides, nonmetal oxides, or mixtures thereof.

19. The organized suspension of claim 10 wherein the biological fibers, synthetic fibers, biological membrane and synthetic membrane contains one or more environmental nutrients or contaminants.

20. The organized suspension of claim 19 wherein the environmental nutrients or contaminants comprise at least one organic or non-organic compound or element.
